(19) United States
(12) Patent Application Publication
(10) Pub. No.: US 2010/0176644 A1
(43) Pub. Date: Jul. 15, 2010

(54) LEG SUPPORT ASSEMBLY FOR A SMALL CHILD

(75) Inventor: Xuan T. Avallone, Milford, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/351,893

(22) Filed: Jan. 12, 2009

(51) Int. Cl. A47C 7/50; E05C 19/16

(52) U.S. Cl. 297/423.1; 292/251.5

(57) ABSTRACT

A vehicle includes a front seat and a rear seat. A leg support assembly is secured to the front seat and moveable between the open position and the closed position. The leg support assembly is at least partially supported on the rear seat when located in the open position.

### TECHNICAL FIELD

The present invention relates generally to a seat for a vehicle, and more specifically, to a seat in a vehicle with a leg support for a child.

### BACKGROUND OF THE INVENTION

Passenger seats within transport vehicles are typically designed to safely support an adult occupant. Therefore, child safety seats are commonly used to adapt the passenger seat for a child. Typically, the child safety seats are removably secured to the vehicle seats using the vehicles restraint system. Child safety seats are commonly secured on a rear seat of the vehicle and are recommended for children up to a certain height and weight.

Some children are small enough to still require the use of a safety seat but are large enough that their legs will dangle off of the safety seat. Typically, there is not enough space on the vehicle seat in front of the safety seat to support the child's legs. However, having the child's legs hang off the seat can be uncomfortable.

Placing blocks or footstools in the foot well in front of the child may provide the necessary support. However, this type of support is not adjustable based upon the size of the child, and takes up space within the vehicle even when the child is not in the safety seat.

### SUMMARY OF THE INVENTION

A leg support assembly in a transport vehicle for use by a child is desired. The leg support assembly includes a platform portion moveable between an open position and a closed position. The leg support assembly is at least partially supportable on a seat when located in the open position. A plurality of bracket assemblies are configured to movably retain the platform portion to a second seat. A closure mechanism selectively retains the platform portion in the closed position. An extender portion is at least partially located within an opening defined by the platform portion.

The seat includes a seat base and a seat back. The leg support assembly is secured to the seat back and moveable between the open position and the closed position. The leg support assembly is supportable on another seat when located in the open position.

The seat may be a front seat for a vehicle. The vehicle may also include a rear seat. The leg support assembly is secured to the front seat and moveable between the open position and the closed position. The leg support assembly is at least partially supported on the rear seat when located in the open position.

The above features and advantages, and other features and advantages of the present invention will be readily apparent from the following detailed description of the preferred embodiments and best modes for carrying out the present invention when taken in connection with the accompanying drawings.

### BRIEF DESCRIPTION OF THE DRAWINGS

FIG. 1 is a schematic perspective illustration of a vehicle having a leg support assembly located in an open position;

FIG. 2 is a schematic perspective illustration of the leg support assembly of FIG. 1 in a closed position;

FIG. 3 is a schematic perspective illustration of the leg support assembly of FIG. 1 and 2 with a platform extender in a support position; and

FIG. 4 is a schematic perspective illustration of the platform extender of FIG. 3 in a storage position.

### DESCRIPTION OF THE PREFERRED EMBODIMENTS

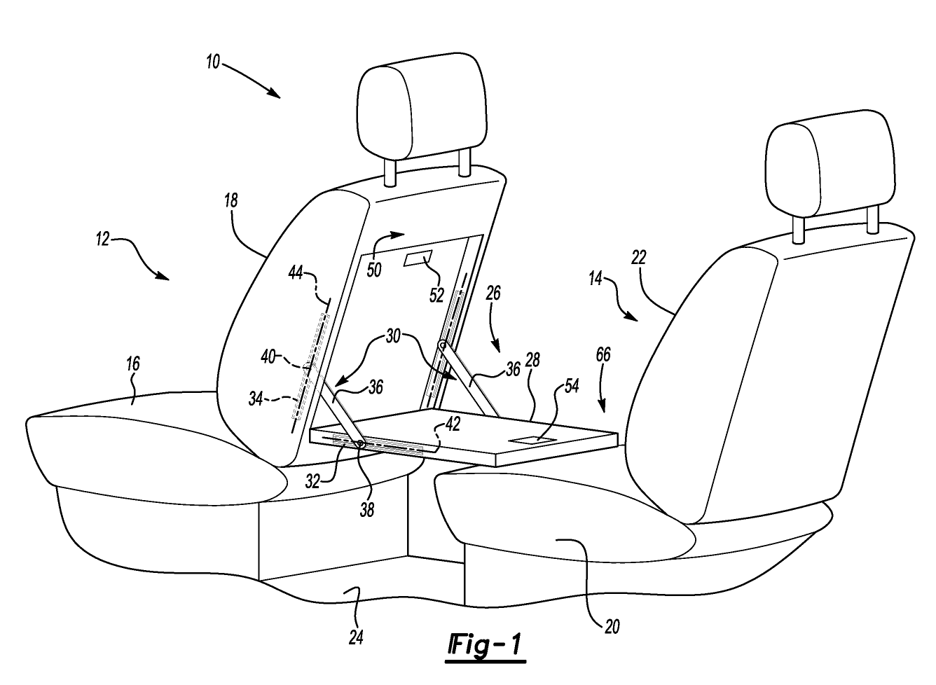

Referring to the Figures, wherein like reference numbers refer to the same or similar components throughout the several views, FIG. 1 is a schematic view of an exemplary vehicle 10, having a vehicle front seat 12 and a vehicle rear seat 14. The vehicle front seat 12 includes a front seat base 16 and a front seat back 18. Likewise, the vehicle rear seat 14 includes a rear seat base 20 and a rear seat back 22. A foot well 24 extends from the front seat 12 to the rear seat 14. A leg support assembly 26 is supported on the front seat back 18 and extends toward the rear seat base 20. The leg support assembly 26 has a platform portion 28 which may be partially supported by the rear seat base 20 of the rear seat 14, as shown. The space below the platform portion 28 formed by the front seat 12 the rear seat 14 and the foot well 24 may be used to store objects within the vehicle 10.

The leg support assembly 26 includes a plurality of hinge bracket assemblies 30 which moveably attach the leg support assembly 26 to the front seat 12. Both of the hinge bracket assemblies 30 operate in a similar manner. However, for simplicity the operation of one of the hinge bracket assemblies 30 is described herein. The hinge bracket assembly 30 includes a platform bracket 32 and a seat bracket 34. A connector 36 is rotatably connected to the platform bracket 32 with a platform sliding pin 38. The connector 36 is also rotatably connected, at an opposing end, to the seat bracket 34 with a seat sliding pin 40.

The platform sliding pin 38 can move axially within a slot (not numbered) of the platform bracket 32. Moving the platform sliding pin 38 allows the position of the platform portion 28 to be adjusted along a first axis 42 defined by the platform bracket 32. Likewise, the seat sliding pin 40 can move axially within a slot (not numbered) of the seat bracket 34. Moving the seat sliding pin 40 allows the position of the platform portion 28 to be adjusted along a second axis 44 defined by the seat bracket 34. Additionally, the connector 36 is rotatable with respect to the platform sliding pin 38 and with respect to the seat sliding pin 40.

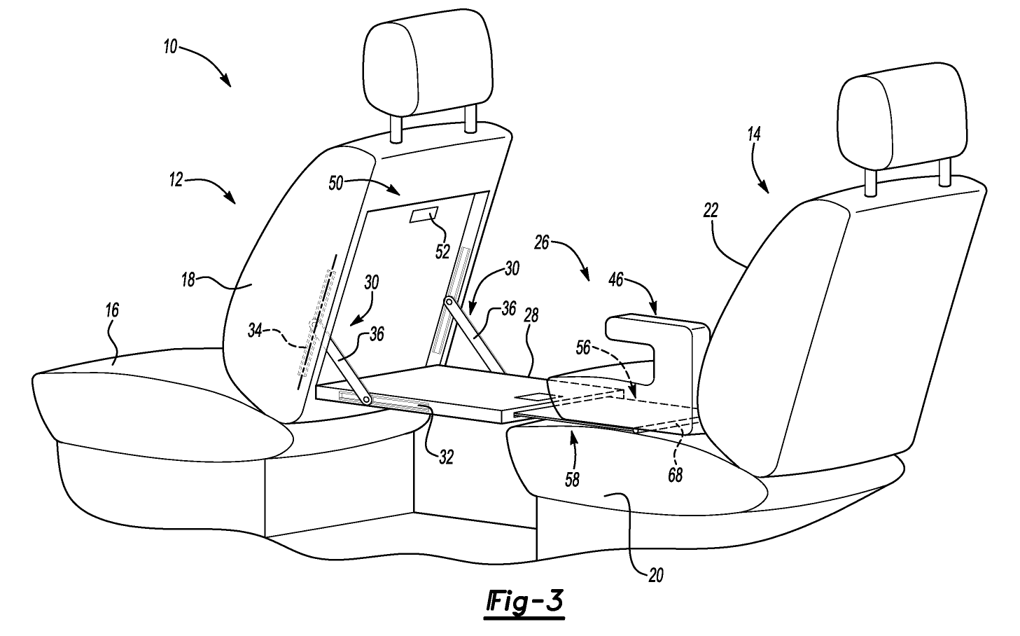

Movement of the connector 36 along the first axis 42, the second axis 44 and rotatably with respect to the platform sliding pin 38 and the seat sliding pin 40 allows the platform portion 28 to be placed in an infinite number of positions. FIG. 1 illustrates the platform portion 28 as generally perpendicular to the front seat back 18 or generally parallel to the foot well 24. However, other positions of the platform portion 28 may be utilized as desired by the vehicle occupants. Adjustments to the platform portion 28 may be made based upon factors such as, the position of the front seat back 18, the length of the child's legs occupying a safety seat 46 (shown in FIG. 3) which is located on the rear seat base 20, etc. For example, a child in a safety seat 46 on the rear seat 14 may not be comfortable with their feet parallel to the foot well 24. Therefore, the platform portion 28 may be non-parallel with the foot well 24 and may correspond to an angle of an occupant's feet. Another example is, depending on the incline of the front seat back 18 that is desired by the vehicle's operator, the platform portion 28 may be non-perpendicular with the front seat back 18 of the front seat 12.

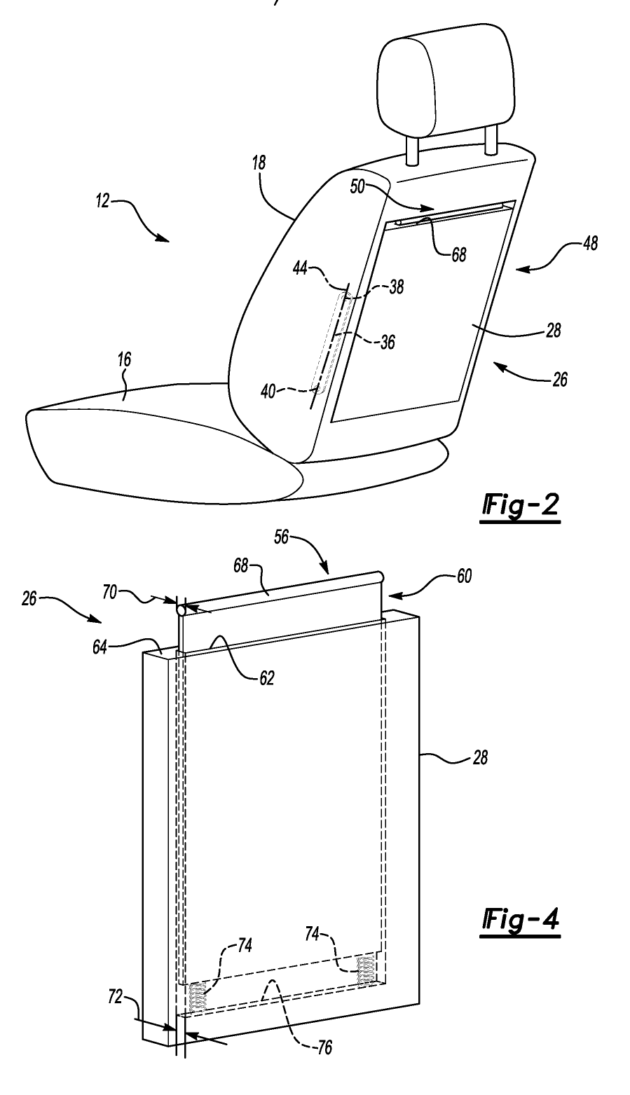

FIG. 2 illustrates the leg support assembly 26 in a closed position 48. The closed position 48 corresponds to the platform portion 28 in a position parallel with the front seat back 18. That is, the first axis 42 is parallel with the front seat back 18. When in the closed position 48 the first axis 42 may also be parallel with the second axis 44.

A closure mechanism 50 retains the platform portion 28 in the closed position 48. In the embodiment shown the closure mechanism 50 includes a seat magnetic strip 52 that is secured to the front seat back 18. A similar platform magnetic strip 54 (shown in FIG. 1) is located on the platform portion 28. When the platform portion 28 is moved into the closed position 48 the platform magnetic strip 54 contacts the seat magnetic strip 52. Only a portion of the seat magnetic strip 52 must be in contact with the platform magnetic strip 54 to retain the platform portion 28 in the closed position 48. Other alternates for a closure mechanism 50 may be utilized to selectively retain the platform portion 28 in the closed position 48. One skilled in the art would be able to determine which type of closure mechanism 50 may be best suited to a particular application.

Referring to FIG. 3, the size of the safety seat 46 may be large enough that there is not sufficient space on the rear seat base 20 to support the platform portion 28 as illustrated in FIG. 1. In this instance, a platform extender 56 may extend from the platform portion 28. The platform extender 56 is placed on the rear seat base 20. The safety seat 46 is located over the platform extender 56, such that the platform extender 56 is located between the rear seat base 20 and the safety seat 46. The weight of the safety seat 46, and the child when the safety seat 46 is occupied, assist in retaining the platform extender 56 in the support position 58, as shown in FIG. 3. The platform extender 56 is preferably a flexible material to easily fit between the rear seat base 20 and the safety seat 46. The platform extender 56 may also include a material or a coating of a material that would provide friction with the rear seat base 20. For example, the platform extender 56 may be of a rubber material or coating.

FIG. 4 illustrates the platform extender 56 in a retracted position 60. An opening 62 is defined by the platform portion 28 and is located on an end portion 64. The end portion 64 is closest to the rear seat 14 when the leg support assembly 26 is in an open position 66, as shown in FIGS. 1 and 3. The platform extender 56 is substantially located within the opening 62 when in the retracted position 60. A handle 68 is attached to the platform extends 56 in an arrangement that ensures the handle 68 is easily reached by an operator. In the embodiment shown, the handle 68 has a handle width 70 that is greater than an opening width 72 of the opening 62. The handle width 70 ensures that the handle 68 does not enter into the opening 62 when the platform extender 56 is in the retracted position 60.

The platform extender 56 is retained in the retracted position 60 by at least one spring 74 attached to an inner wall 76 of the platform portion 28. The spring 74 provides a sufficient amount of force on the platform extender 56 to retract and retain the platform extender 56 in the retracted position 60. However, the spring force may be easily countered by the weight of a safety seat 46 (shown in FIG. 3) to retain the platform extender 56 in the extended position 58 (shown in FIG. 3) when desired.

Although, the above example describes the leg support assembly 26 for use in an automotive vehicle 10, other types of passenger transportation would benefit by the incorporation of the leg support assembly 26 as well.

While the best modes for carrying out the invention have been described in detail, those familiar with the art to which this invention relates will recognize various alternative designs and embodiments for practicing the invention within the scope of the appended claims.

1. A vehicle comprising:
a front seat;
a rear seat, located behind and spaced apart from the front seat; and
a leg support assembly secured to the front seat and moveable between an open position and a closed position, wherein the leg support assembly is at least partially supported on the rear seat when located in the open position.

2. The vehicle of claim 1, wherein the leg support assembly further comprises:
a platform portion;
a plurality of bracket assemblies to movably retain the platform portion to a back of the front seat; and
a closure mechanism to selectively retain the platform portion in the closed position.

3. The vehicle of claim 2, wherein the closure mechanism further comprises a seat magnet secured to the front seat back and a platform magnet secured to the platform.

4. The vehicle of claim 2, wherein the platform portion is supported on the rear seat.

5. The vehicle of claim 2, further comprising an opening defined by the platform portion and a platform extender at least partially located within the opening.

6. The vehicle of claim 5, wherein the platform extender is supported on the rear seat.

7. The vehicle of claim 5, wherein the platform extender is retractably secured to the platform portion by at least one spring, and wherein the at least one spring is located within the opening defined by the platform portion.

8. The vehicle of claim 2, wherein each of the plurality of bracket assemblies further comprises:
a seat hinge bracket located on the back of the front seat;
a platform hinge bracket located on the platform portion;
a connector extending between the seat hinge bracket and the platform hinge bracket;
a seat sliding pin to rotatably and slidably attach the connector to the seat hinge bracket; and
a platform sliding pin to rotatably and slidably attach the connector to the platform portion.

9. The vehicle of claim 8, wherein the platform hinge bracket defines a first axis, and wherein the first axis is generally parallel with the back of the front seat when the platform portion is in the closed position.

10. A seat for a vehicle having another seat comprising:
a seat base;
a seat back;
a leg support assembly secured to the seat back and moveable between an open position and a closed position, wherein the leg support assembly is at least partially supportable on said another seat when located in the open position.

11. The seat of claim 10, wherein the leg support assembly further comprises:
a platform portion;
a plurality of bracket assemblies to movably retain the platform portion to the seat back; and
a closure mechanism to selectively retain the platform portion in the closed position.

12. The seat of claim 11, wherein the closure mechanism further comprises a seat magnet secured to the seat back and a platform magnet secured to the platform.

13. The vehicle of claim 11, further comprising an opening defined by the platform portion and a platform extender at least partially located within the opening.

14. The vehicle of claim 13, wherein the platform extender is retractably secured to the platform portion by at least one spring, and wherein the at least one spring is located within the opening defined by the platform portion.

15. The seat of claim 11, wherein each of the bracket assemblies further comprises:
a seat hinge bracket located on the seat back;
a platform hinge bracket located on the platform portion;
a connector extending between the seat hinge bracket and the platform hinge bracket;
a seat sliding pin to rotatably and slidably attach the connector to the seat hinge bracket; and
a platform sliding pin to rotatably and slidably attach the connector to the platform portion.

16. The seat of claim 15, wherein the platform hinge bracket defines a first axis, and wherein the first axis is generally parallel with the seat back when the platform portion is in the closed position.

17. A leg support assembly comprising:
a platform portion moveable between an open position and a closed position, wherein the leg support assembly is supportable on a first seat when located in the open position;
a plurality of bracket assemblies configured to movably retain the platform portion to a second seat;
a closure mechanism to selectively retain the platform portion in the closed position; and
a platform extender at least partially located within an opening defined by the platform portion.

18. The leg support assembly of claim 17, wherein the platform extender is retractably secured to the platform portion by at least one spring, and wherein the at least one spring is located within the opening defined by the platform portion.

19. The leg support assembly of claim 17, wherein each of the bracket assemblies further comprises:
a seat hinge bracket to mount to the second seat;
a platform hinge bracket located on the platform portion;
a connector extending between the seat hinge bracket and the platform hinge bracket;
a seat sliding pin to rotatably and slidably attach the connector to the seat hinge bracket; and
a platform sliding pin to rotatably and slidably attach the connector to the platform portion.
